(19) United States
(12) Patent Application Publication
(10) Pub. No.: US 2017/0161464 A1
(43) Pub. Date: Jun. 8, 2017

(54) ACTIVITY RECORDING SYSTEM, ACTIVITY RECORDING APPARATUS, ACTIVITY RECORDING METHOD, AND PROGRAM

(71) Applicant: OMRON HEALTHCARE CO., LTD., Kyoto (JP)

(72) Inventor: Yuki TAKANO, Kyoto (JP)

(21) Appl. No.: 15/440,078

(22) Filed: Feb. 23, 2017

Related U.S. Application Data
(63) Continuation of application No. PCT/JP2015/073624, filed on Aug. 21, 2015.

(30) Foreign Application Priority Data
Aug. 29, 2014 (JP) 2014-175837

(51) Int. Cl. G06F 19/00

(52) U.S. Cl. CPC G06F 19/3481; G06F 19/322

(57) ABSTRACT

An activity recording system includes an activity recording apparatus that detects information corresponding to motion of a user and records the detected information as main data, a mobile terminal that detects information that corresponds to motion of the user and is at least a portion of the information that is detected by the activity recording apparatus, and records the detected information as supplementary data, and a data processor that collects the main data and the supplementary data and generates log data. When the main data has a missing period, if the supplementary data has partial data for a period included in the missing period, the data processor compensates for data in the missing period in the main data with use of the partial data.

### CROSS REFERENCE TO RELATED APPLICATIONS

This application claims the benefit of priority to Japanese Patent Application No. 2014-175837 filed on Aug. 29, 2014 and is a Continuation Application of PCT Application No. PCT/JP2015/073624 filed on Aug. 21, 2015. The entire contents of each application are hereby incorporated herein by reference.

### BACKGROUND OF THE INVENTION

1. Field of the Invention

The present invention relates to an activity recording system, an activity recording apparatus, an activity recording method, and a program.

2. Description of the Related Art

The recent increase in health consciousness has been accompanied by the popularization of activity recording apparatuses such as activity meters that are carried by users and detect and store information corresponding to motion of the user. By presenting the detected information to the user, such an activity recording apparatus promotes a desire for health management in the user, and it is desirable for the activity recording apparatus to be used continuously every day.

However, due to being used while being carried by the user, it is possible for the user to forget to carry the activity recording apparatus, and if the user forgets to carry the activity recording apparatus, data will be missing for that period.

In order to avoid missing data, a system is known in which the activity recording apparatus or a mobile terminal (e.g., a smartphone) carried by the user detects that the user has forgotten to carry the activity recording apparatus, and the fact that the user forgot to carry the activity recording apparatus is announced to the user via a mobile terminal (e.g., see JP 2009-9350A and JP 2002-133555A).

Furthermore, in order to avoid missing data, an activity recording apparatus is also known that compensates for data for the missing period with use of similar recorded past data or data from before/after the missing period (e.g., see JP 2010-142273A, JP 2003-135409A and JP 2003-044595A).

### SUMMARY OF THE INVENTION

In a system that detects that a user has forgotten to carry the activity recording apparatus and makes an announcement to the user, even if an announcement is made to the user, whether or not the activity recording apparatus will then actually be carried depends on the user's situation, and it has not been possible to sufficiently avoid missing data.

Also, even if data for the missing period is compensated for with use of similar past data or data from before/after the missing period, there is a possibility that the actual activity of the user will not be reflected in the missing period, and there have been problems in terms of the reliability of the compensated data.

Preferred embodiments of the present invention provide an activity recording system, an activity recording apparatus, an activity recording method, and a program that can maintain the continuity and the reliability of data even if the user forgets to carry the activity recording apparatus.

An activity recording system according to one aspect of a preferred embodiment of the present invention includes: an activity recording apparatus that is carried by a user, detects information corresponding to motion of the user, and records the detected information as main data; a mobile terminal that is carried by the user, detects information that corresponds to motion of the user and is at least a portion of the information that is detected by the activity recording apparatus, and records the detected information as supplementary data; and a data processor that collects the main data and the supplementary data and generates log data, wherein in a case where the main data has a missing period, if the supplementary data has partial data for a period included in the missing period, the data processor compensates for data in the missing period in the main data with use of the partial data.

Also, an activity recording apparatus according to an aspect of a preferred embodiment of the present invention is an activity recording apparatus that is carried by a user, detects information corresponding to motion of the user, and records the detected information as main data, the activity recording apparatus including: a communicator that communicates with a mobile terminal that is carried by the user, detects information that corresponds to motion of the user and is at least a portion of the information that is detected by the activity recording apparatus, and records the detected information as supplementary data; and a data processor that generates log data with use of the main data and the supplementary data that was received from the mobile terminal via the communicator, wherein in a case where the main data has a missing period, if the supplementary data has partial data for a period included in the missing period, the data processor compensates for data in the missing period in the main data with use of the partial data.

Furthermore, an activity recording apparatus according to an aspect of a preferred embodiment of the present invention is an activity recording apparatus that is carried by a user, detects information corresponding to motion of the user, and records the detected information, the activity recording apparatus including: a communicator that communicates with a mobile terminal that is carried by the user, detects information that corresponds to motion of the user and is at least a portion of the information that is detected by the activity recording apparatus, and records the detected information; and a sensor that senses whether or not the activity recording apparatus is being carried by the user, wherein the sensor transmits to the mobile terminal, via the communicator, a control signal that controls operation of the mobile terminal such that detection of information by the mobile terminal is started if it is sensed that the activity recording apparatus is not being carried by the user, and detection of information by the mobile terminal is stopped if it is sensed that the activity recording apparatus is being carried by the user.

Moreover, an activity recording method according to an aspect of a preferred embodiment of the present invention includes the following steps performed by a computer: a step of collecting main data acquired by an activity recording apparatus that is carried by a user and detects information corresponding to motion of the user, and supplementary data acquired by a mobile terminal that is carried by the user and detects information that corresponds to motion of the user and is at least a portion of the information that is detected by the activity recording apparatus; and a step of, in a case where the main data has a missing period, if the supplementary data has partial data for a period included in the missing period, compensating for data in the missing period in the main data with use of the partial data.

Moreover, a non-tangible recording medium containing a program according to an aspect of a preferred embodiment of the present invention causes a computer to perform the steps of the activity recording method described above.

According to various preferred embodiments of the present invention, it is possible to provide an activity recording system, an activity recording apparatus, an activity recording method, and a non-tangible recording medium containing a program that maintain the continuity and the reliability of data even if the user forgets to carry the activity recording apparatus.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram showing an example of a configuration of an activity recording system for illustrating a preferred embodiment of the present invention.

FIG. 2 is a flowchart showing an example of operations of the activity recording system in FIG. 1.

FIG. 3 is a block diagram showing another example of a configuration of the activity recording system for illustrating a preferred embodiment of the present invention.

FIG. 4 is a flowchart showing an example of operations of the activity recording system in FIG. 3.

FIG. 5 is a block diagram showing an example of a configuration of an activity recording system for illustrating a preferred embodiment of the present invention.

FIG. 6 is a flowchart showing an example of operations of the activity recording system in FIG. 5.

FIG. 7 is a block diagram showing an example of a configuration of an activity recording system for illustrating a preferred embodiment of the present invention.

FIG. 8 is a flowchart showing an example of operations of the activity recording system in FIG. 7.

### DETAILED DESCRIPTION OF THE PREFERRED EMBODIMENTS

Hereinafter, preferred embodiments of the present invention will be described with reference to the drawings.

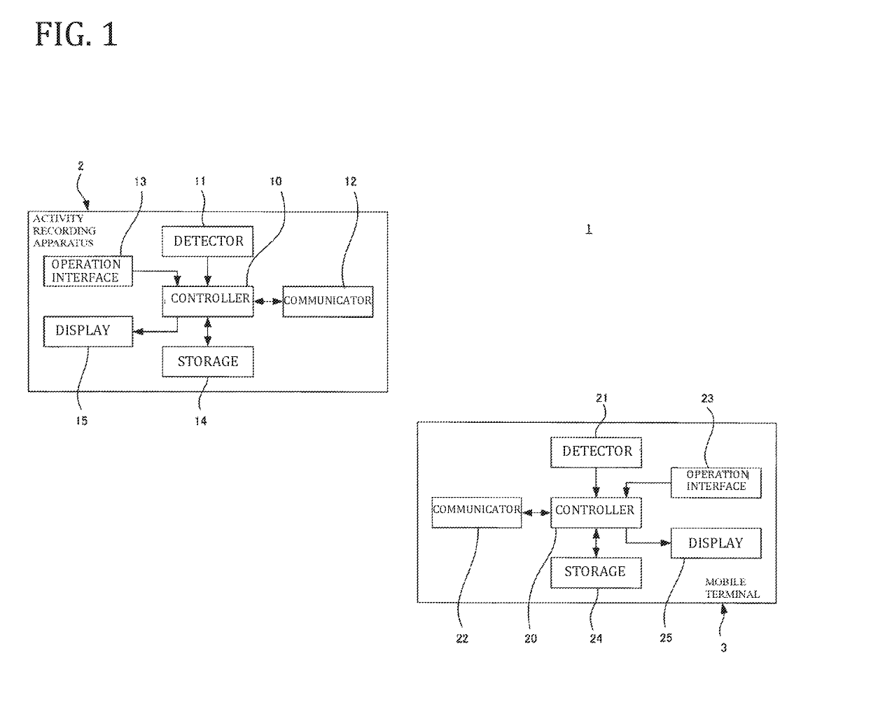

FIG. 1 shows an example of the configuration of an activity recording system for illustrating a preferred embodiment of the present invention.

An activity recording system 1 includes an activity recording apparatus 2 and a mobile terminal 3.

The activity recording apparatus 2 is used while being carried by a user. For example, it is carried by the user by being attached to the user with use of a clip affixed to the user's clothes, a wrist band wrapped around the user's wrist, or the like, or is inserted into a pocket of the user's clothes, for example.

The activity recording apparatus 2 includes a controller 10, a detector 11, a communicator 12, an operation interface 13, a storage 14, and a display 15 as main elements.

The detector 11 detects information corresponding to motion of the user who is carrying the activity recording apparatus 2 (referred to hereinafter as activity information), and includes various types of sensors that correspond to the activity information that is to be detected. Examples of activity information include the number of steps, walking distance, activity intensity, and calorie consumption. The sensors that detect such activity information are typically acceleration sensors, and angular velocity sensors are also used in order to detect the user's orientation and the like in order to raise detection precision.

The communicator 12 includes an interface that performs communication with other devices. Examples of the interface include a wireless communication interface that enables direct communication between devices over a relatively short distance, such as ANT or Bluetooth (registered trademark), and a wireless communication interface that enables indirect communication between devices via an access point, such as WI-FI (registered trademark).

The operation interface 13 includes devices such as buttons or a touch sensor, and is used to input various types of instructions to the activity recording apparatus 2.

The storage 14 includes a storage medium such as a flash memory or a ROM (Read Only Memory), stores data indicating activity information detected by the detector 11, stores data received via the communicator 12, and stores information necessary for operation of the activity recording apparatus 2.

The display 15 includes a display panel such as a liquid crystal panel, and displays various types of information such as activity information detected by the detector 11.

The controller 10 preferably includes a processor that executes a program or programs stored in the storage 14, and performs overall management and control of the activity recording apparatus 2 in accordance with various instructions that have been input to the operation interface 13.

The mobile terminal 3 is used while being carried by the user, and is preferably a terminal that is normally carried by the user in their daily life as a habit. One example of this terminal is a mobile phone that can execute application programs, such as a smartphone.

The mobile terminal 3 includes a controller 20, a detector 21, a communicator 22, an operation interface 23, a storage 24, and a display 25 as main elements.

The detector 21 detects activity information regarding the user who is carrying the mobile terminal 3, and includes various types of sensors that correspond to the activity information that is to be detected. Note that it is sufficient that the detector 21 detects at least a portion of the activity information that is detected by the detector 11 of the activity recording apparatus 2. Considering differences in the specifications of the sensors built into the detector 11 and the sensors built into the detector 21, differences in how the activity recording apparatus 2 and the mobile terminal 3 are held, and the like, the activity information that is to be detected by the detector 21 is appropriately set within the range of information for which it is possible to guarantee a level of precision equivalent to the detection precision of the activity information detected by the detector 11.

The communicator 22 includes an interface that performs communication with other devices. Examples of the interface include a wireless communication interface that enables direct communication between devices over a relatively short distance, such as ANT or Bluetooth (registered trademark), and a wireless communication interface that enables indirect communication between devices via an access point, such as WI-FI (registered trademark).

The operation interface 23 includes devices such as buttons or a touch sensor, and is used to input various types of instructions to the mobile terminal 3.

The storage 24 includes a storage medium such as a flash memory or a ROM (Read Only Memory), stores data indicating activity information detected by the detector 21, stores data received via the communicator 22, and stores information necessary for operation of the mobile terminal 3.

The display 25 includes a display panel such as a liquid crystal panel, and displays various types of information such as activity information detected by the detector 21.

The controller 20 preferably includes a processor that executes programs stored in the storage 24, and performs overall management and control of the mobile terminal 3 in accordance with various instructions that have been input to the operation interface 23.

In the activity recording system 1, data that indicates activity information detected by the activity recording apparatus 2 and is stored in the activity recording apparatus 2 (referred to hereinafter as “main data”) is collected, data that indicates activity information detected by the mobile terminal 3 and is stored in the mobile terminal 3 (referred to hereinafter as “supplementary data”) is also collected, and log data is generated using the main data and the supplementary data. In the present preferred embodiment, the controller 10 of the activity recording apparatus 2 also has the function of a data processor that generates the log data.

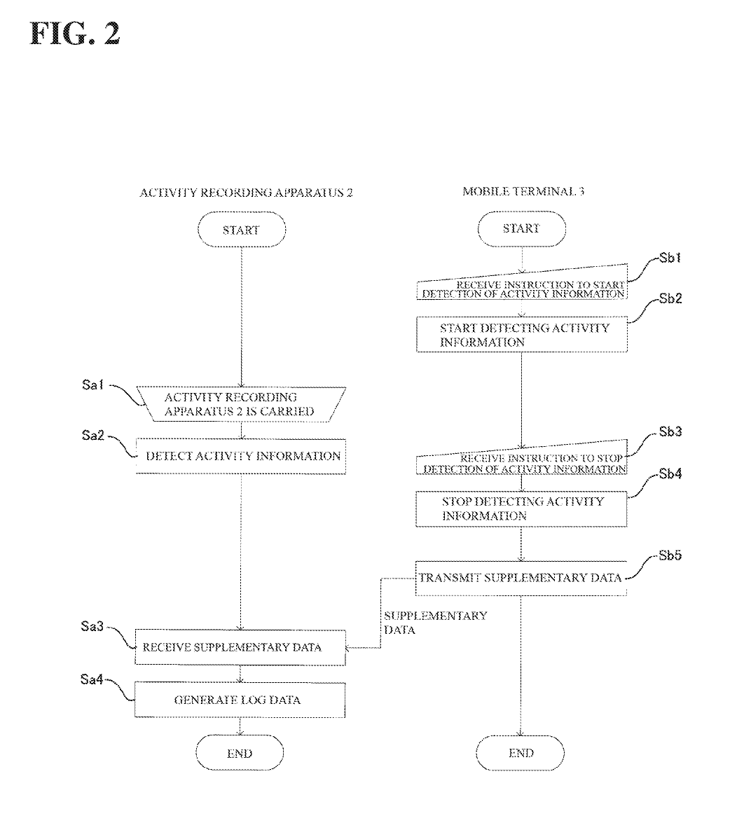

FIG. 2 shows an example of operations of the activity recording system 1.

The example shown in FIG. 2 is an example in which activity information has not been detected by the activity recording apparatus 2 at first due to the user forgetting to carry the activity recording apparatus 2, but then the activity recording apparatus 2 is carried by the user, and activity information starts to be detected by the activity recording apparatus 2.

First, an instruction to start the detection of activity information by the mobile terminal 3 is input to the operation interface 23 of the mobile terminal 3 by the user (step Sb1), and the detection of activity information by the detector 21 is started under control of the controller 20 (step Sb2).

Subsequently, the activity recording apparatus 2 is carried by the user (step Sa1), and activity information is detected by the detector 11 of the activity recording apparatus 2 (step Sa2).

Due to the activity recording apparatus 2 being carried, an instruction to stop the detection of activity information by the mobile terminal 3 is input to the operation interface 23 of the mobile terminal 3 by the user (step Sb3), and the detection of activity information by the detector 21 is stopped under control of the controller 20 (step Sb4).

The supplementary data stored in the storage 24 of the mobile terminal 3 is transmitted to the activity recording apparatus 2 at an appropriate timing (step Sb5). Examples of the supplementary data transmission timing include the time at which the detection of activity information by the mobile terminal 3 is stopped, and the time at which a supplementary data transmission instruction is input to the operation interface 23 of the mobile terminal 3.

The supplementary data transmitted by the mobile terminal 3 is then received by the activity recording apparatus 2 (step Sa3), and the controller 10 of the activity recording apparatus 2 that received the supplementary data generates log data using the main data stored in the storage 14 and the received supplementary data (step Sa4).

In the generation of the log data, the controller 10 first specifies a main data missing period, which is the period in which activity information was not detected by the activity recording apparatus 2 due to the user forgetting to carry the activity recording apparatus 2. Next, the controller 10 extracts partial data for a period included in the missing period from the supplementary data received from the mobile terminal 3. The controller 10 then compensates for data in the missing period in the main data with use of the extracted partial data.

In this way, data for the missing period in the main data of the activity recording apparatus 2 is compensated for with use of the supplementary data from the mobile terminal 3, thus making it possible to maintain the continuity of the main data. Also, the supplementary data from the mobile terminal 3 reflects the actual activity of the user, thus making it possible to maintain the reliability of the main data that was generated using the supplementary data.

Note that although the controller 10 of the activity recording apparatus 2 functions as the data processor in the above description, the controller 20 of the mobile terminal 3 can also function as the data processor. In this case, the main data stored in the storage 14 of the activity recording apparatus 2 is transmitted from the activity recording apparatus 2 to the mobile terminal 3.

Also, the data processor may be a computer device that is provided separate from the activity recording apparatus 2 and the mobile terminal 3. In this case, the main data stored in the storage 14 of the activity recording apparatus 2 and the supplementary data stored in the storage 24 of the mobile terminal 3 are transmitted to the computer device that constitutes the data processor. Note that the computer device that may define the data processor may be a server located in a cloud (computer network), for example.

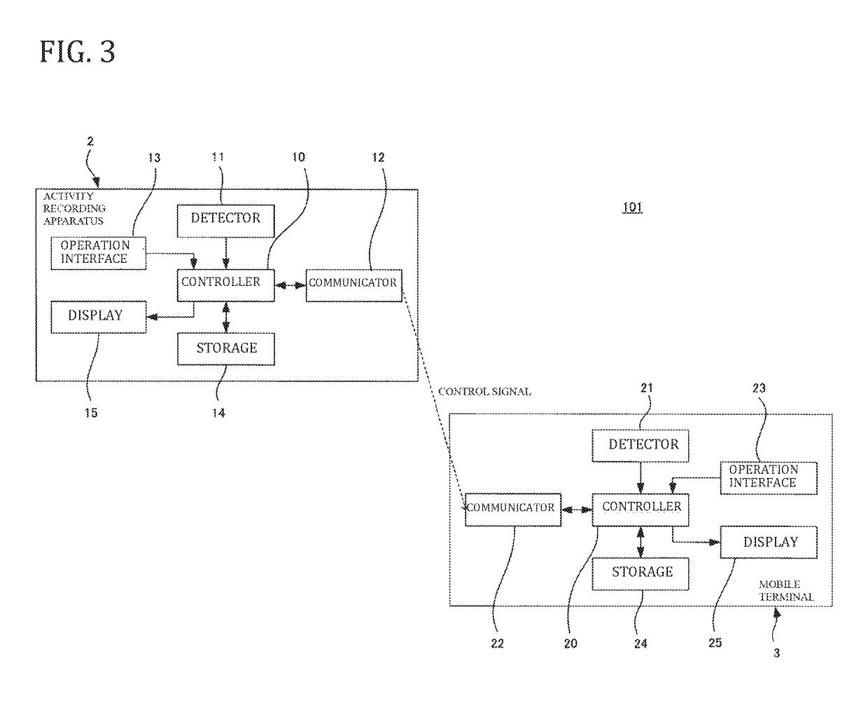

FIG. 3 is a block diagram showing another example of the configuration of the activity recording system for illustrating another preferred embodiment of the present invention. Note that elements that are the same as those in the activity recording system 1 described above are denoted by the same reference signs, and descriptions will not be given for them or will be abbreviated.

In the activity recording system 1 described above, the starting and the stopping of the detection of activity information by the mobile terminal 3 is controlled according to a user instruction, but in an activity recording system 101 shown in FIG. 3, a sensor that senses whether or not the activity recording apparatus 2 is being carried by the user is provided, and the detection of activity information by the mobile terminal 3 is controlled by the sensor. In this preferred embodiment, the sensor is provided in the activity recording apparatus 2, and the controller 10 of the activity recording apparatus 2 also defines and functions as the sensor.

The controller 10 senses whether or not the activity recording apparatus 2 is being carried based on the pattern of detection of activity information by the detector 11. For example, it can be sensed that the activity recording apparatus 2 is not being carried if output from sensors such as the acceleration sensors and the angular velocity sensors built into the detector 11 has not changed for a predetermined time, and it can be sensed that the activity recording apparatus 2 is being carried if the output from the sensors has changed.

If it has been sensed that the activity recording apparatus 2 is not being carried, the controller 10 starts the detection of activity information by the mobile terminal 3, whereas if it has been sensed that the activity recording apparatus 2 is being carried, the controller 10 causes a control signal that stops the detection of activity information by the mobile terminal 3 to be transmitted from the activity recording apparatus 2 to the mobile terminal 3 using communication performed between the activity recording apparatus 2 and the mobile terminal 3 via the communicators 12 and 22.

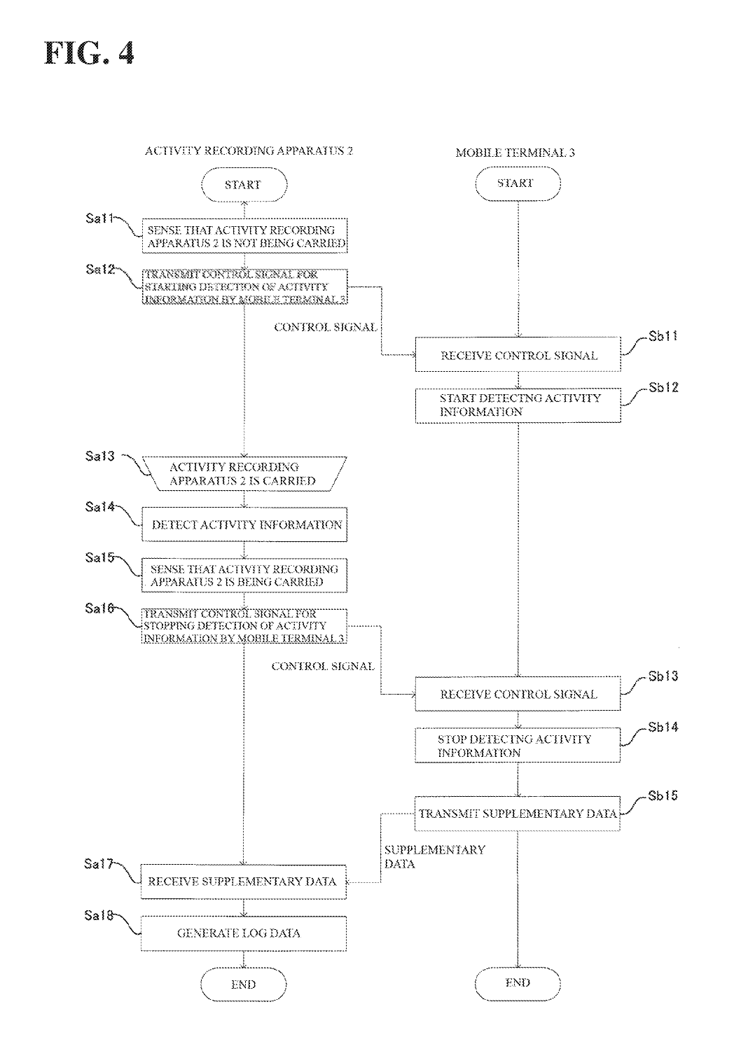

FIG. 4 shows an example of operations of the activity recording system 101.

The example shown in FIG. 4 is also an example in which activity information has not been detected by the activity recording apparatus 2 at first due to the user forgetting to carry the activity recording apparatus 2, but then the activity recording apparatus 2 is carried by the user, and activity information starts to be detected by the activity recording apparatus 2.

First, the controller 10 of the activity recording apparatus 2 senses whether or not the activity recording apparatus 2 is being carried by the user. Here, the activity recording apparatus 2 is not being carried by the user, and there is no change in the output of the sensors built into the detector 11 of the activity recording apparatus 2, and therefore it is sensed that the activity recording apparatus 2 is not being carried (step Sa11).

Upon sensing that the activity recording apparatus 2 is not being carried, the controller 10 causes a control signal that starts the detection of activity information by the mobile terminal 3 to be transmitted from the activity recording apparatus 2 to the mobile terminal 3 (step Sa12).

The control signal transmitted by the activity recording apparatus 2 is received by the mobile terminal 3 (step Sb11), and in the mobile terminal 3 that received the control signal, the detection of activity information by the detector 21 is started under control of the controller 20 (step Sb12).

Subsequently, when the activity recording apparatus 2 is carried by the user (step Sa13), activity information is detected by the detector 11 of the activity recording apparatus 2 (step Sa14).

There is then a change in the output of the sensors built into the detector 11, and the controller 10 of the activity recording apparatus 2 senses that the activity recording apparatus 2 is being carried (step Sa15).

Upon sensing that the activity recording apparatus 2 is being carried, the controller 10 causes a control signal that stops the detection of activity information by the mobile terminal 3 to be transmitted from the activity recording apparatus 2 to the mobile terminal 3 (step Sa16).

The control signal transmitted by the activity recording apparatus 2 is received by the mobile terminal 3 (step Sb13), and in the mobile terminal 3 that received the control signal, the detection of activity information by the detector 21 is stopped under control of the controller 20 (step Sb14).

The supplementary data stored in the storage 24 of the mobile terminal 3 is transmitted to the activity recording apparatus 2 at an appropriate timing (step Sb15).

The supplementary data transmitted by the mobile terminal 3 is then received by the activity recording apparatus 2 (step Sa17), and the controller 10 of the activity recording apparatus 2 that received the supplementary data generates log data using the main data stored in the storage 14 and the received supplementary data (step Sa18).

In this way, the sensor that senses whether or not the activity recording apparatus 2 is being carried is provided, and the detection of activity information by the mobile terminal 3 is automatically controlled according to the sensing result, thus making it possible to further maintain the continuity of the main data and suppress the power consumption of the mobile terminal 3 in comparison to the case where the detection of activity information by the mobile terminal 3 is controlled by a user instruction that is input to the mobile terminal 3.

Note that although the controller 10 of the activity recording apparatus 2 preferably defines and functions as the data processor that generates log data in the above description, similarly to the activity recording system 1 described above, the controller 20 of the mobile terminal 3 can also function as the data processor, or the data processor can be constituted by a computer device that is provided separate from the activity recording apparatus 2 and the mobile terminal 3.

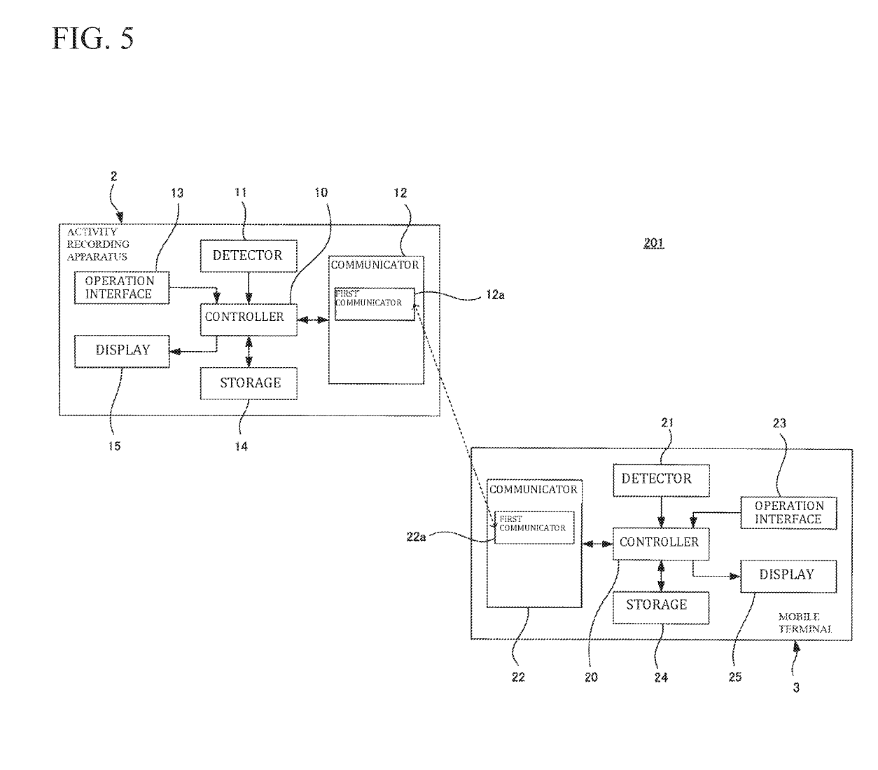

FIG. 5 is a block diagram showing another example of a configuration of an activity recording system for illustrating another preferred embodiment of the present invention.

In the activity recording system 101 described above, whether or not the activity recording apparatus 2 is being carried is sensed based on the pattern of detection of activity information by the activity recording apparatus 2. However, in an activity recording system 201 shown in FIG. 5, the communicators 12 and 22 of the activity recording apparatus 2 and the mobile terminal 3 are each provided with a first communicator that enables direct communication between the activity recording apparatus 2 and the mobile terminal 3, and whether or not the activity recording apparatus 2 is being carried is sensed based on the status of communication between the activity recording apparatus 2 and the mobile terminal 3 via the first communicators. In this preferred embodiment, the sensor preferably is provided in the mobile terminal 3, and the controller 20 of the mobile terminal 3 also defines and functions as the sensor.

One example of the communication interface of a first communicator 12a of the activity recording apparatus 2 and a first communicator 22a of the mobile terminal 3 is a wireless communication interface that enables direct communication between devices over a relatively short distance, such as ANT or Bluetooth. The status of communication between the activity recording apparatus 2 and the mobile terminal 3 via the first communicators 12a and 22a changes according to the distance between the activity recording apparatus 2 and the mobile terminal 3, and communication is interrupted if the activity recording apparatus 2 and the mobile terminal 3 are separated by a predetermined distance or more (e.g., if the user is not carrying the activity recording apparatus 2, but is carrying the mobile terminal 3 and moves away from the activity recording apparatus 2).

Accordingly, the controller 20 of the mobile terminal 3 is able to sense whether or not the activity recording apparatus 2 is being carried by the user based on the status of communication between the activity recording apparatus 2 and the mobile terminal 3 via the first communicators 12a and 22a. For example, it can be sensed that the activity recording apparatus 2 is not being carried if communication via the first communicators 12a and 22a is interrupted, and it can be sensed that the activity recording apparatus 2 is being carried if communication via the first communicators 12a and 22a has been established.

The controller 20 controls the detector 21 such that if it is sensed that the activity recording apparatus 2 is not being carried, the detection of activity information is started, and if it is sensed that the activity recording apparatus 2 is being carried, the detection of activity information is stopped.

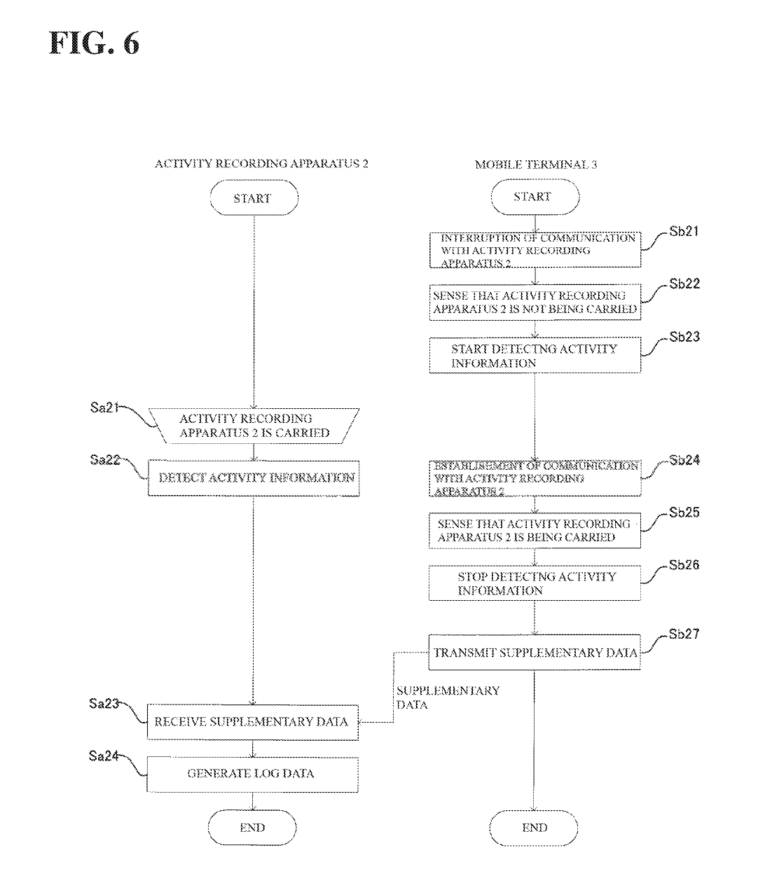

FIG. 6 shows an example of operations of the activity recording system 201.

The example shown in FIG. 6 is also an example in which activity information has not been detected by the activity recording apparatus 2 at first due to the user forgetting to carry the activity recording apparatus 2, but then the activity recording apparatus 2 is carried by the user, and activity information starts to be detected by the activity recording apparatus 2.

First, the controller 20 of the mobile terminal 3 senses whether or not the activity recording apparatus 2 is being carried by the user. Here, the activity recording apparatus 2 is not being carried by the user, the activity recording apparatus 2 and the mobile terminal 3 have become separated due to movement of the user, and communication between the activity recording apparatus 2 and the mobile terminal 3 via the first communicators 12a and 22a has been interrupted (step Sb21), and therefore at that time it is sensed that the activity recording apparatus 2 is not being carried (step Sb22).

Upon sensing that the activity recording apparatus 2 is not being carried, the controller 20 starts the detection of activity information by the detector 21 (step Sb23).

Subsequently, when the activity recording apparatus 2 is carried by the user (step Sa21), activity information is detected by the detector 11 of the activity recording apparatus 2 (step Sa22).

Due to the activity recording apparatus 2 being carried, communication between the activity recording apparatus 2 and the mobile terminal 3 via the first communicator 12a and 22a is established (step Sb24), and the controller 20 of the mobile terminal 3 senses that the activity recording apparatus 2 is being carried (step Sb25).

Upon sensing that the activity recording apparatus 2 is being carried, the controller 20 stops the detection of activity information by the detector 21 (step Sb26).

The supplementary data stored in the storage 24 of the mobile terminal 3 is transmitted to the activity recording apparatus 2 at an appropriate timing (step Sb27).

The supplementary data transmitted by the mobile terminal 3 is then received by the activity recording apparatus 2 (step Sa23), and the controller 10 of the activity recording apparatus 2 that received the supplementary data generates log data using the main data stored in the storage 14 and the received supplementary data (step Sa24).

According to the present preferred embodiment as well, similarly to the activity recording system 101 described above, it is possible to further maintain the continuity of the main data and also suppress the power consumption of the mobile terminal 3.

Note that although the controller 10 of the activity recording apparatus 2 defines and functions as the data processor that generates log data in the above description, similarly to the activity recording system 1 described above, the controller 20 of the mobile terminal 3 can also define and function as the data processor, or the data processor can be a computer device that is provided separate from the activity recording apparatus 2 and the mobile terminal 3.

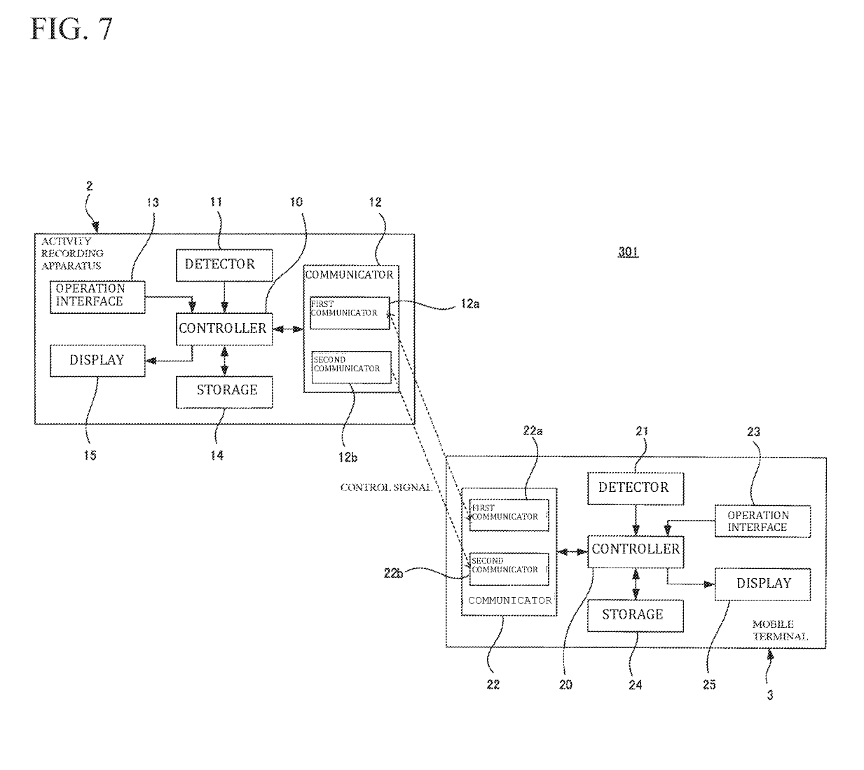

FIG. 7 is a block diagram showing another example of a configuration of an activity recording system for illustrating another preferred embodiment of the present invention.

An activity recording system 301 shown in FIG. 7 is the same as the activity recording system 201 described above in that whether or not the activity recording apparatus 2 is being carried by the user is sensed based on the status of communication between the first communicators 12a and 22a of the activity recording apparatus 2 and the mobile terminal 3, and is different from the activity recording system 201 described above in that the sensor is provided in the activity recording apparatus 2, the controller 10 of the activity recording apparatus 2 also defines and functions as the sensor, and the communicators 12 and 22 of the activity recording apparatus 2 and the mobile terminal 3 are each provided with a second communicator that has a longer communication range than the communication range of direct communication between the activity recording apparatus 2 and the mobile terminal 3 via the first communicators 12a and 22a.

There are no particular limitations on the communication interface of a second communicator 12b of the activity recording apparatus 2 and a second communicator 22b of the mobile terminal 3 as long as it has a longer communication range than the range of communication performed via the first communicators 12a and 22a, and it may be a wireless communication interface that enables direct communication between the activity recording apparatus 2 and the mobile terminal 3 or a wireless communication interface that enables indirect communication via an access point. Note that “communication range” refers to the distance between the activity recording apparatus 2 and the mobile terminal 3 over which communication is able to be maintained between the activity recording apparatus 2 and the mobile terminal 3. In the case where the communication performed via the second communicators 12b and 22b is indirect communication via an access point, even if the distance over which communication is able to be maintained between the access point and the second communicators 12b and 22b is shorter than the communication range of the first communicators 12a and 22a, as long as the distance over which communication is able to be maintained between the activity recording apparatus 2 and the mobile terminal 3 due to being relayed through the access point is longer than the communication range of the first communicators 12a and 22a, then the communication range of the second communicators 12b and 22b is longer than the communication range of the first communicators 12a and 22a.

The controller 10 of the activity recording apparatus 2 is able to sense whether or not the activity recording apparatus 2 is being carried by the user based on the status of communication between the activity recording apparatus 2 and the mobile terminal 3 via the first communicators 12a and 22a. For example, it can be sensed that the activity recording apparatus 2 is not being carried if communication between the activity recording apparatus 2 and the mobile terminal 3 via the first communicators 12a and 22a is interrupted, and it can be sensed that the activity recording apparatus 2 is being carried if communication between the activity recording apparatus 2 and the mobile terminal 3 via the first communicators 12a and 22a has been established.

If it has been sensed that the activity recording apparatus 2 is not being carried, the controller 10 starts the detection of information by the mobile terminal 3, whereas if it has been sensed that the activity recording apparatus 2 is being carried, the controller 10 causes a control signal that stops the detection of information by the mobile terminal 3 to be transmitted from the activity recording apparatus 2 to the mobile terminal 3 using communication performed between the activity recording apparatus 2 and the mobile terminal 3 via the second communicators 12b and 22b.

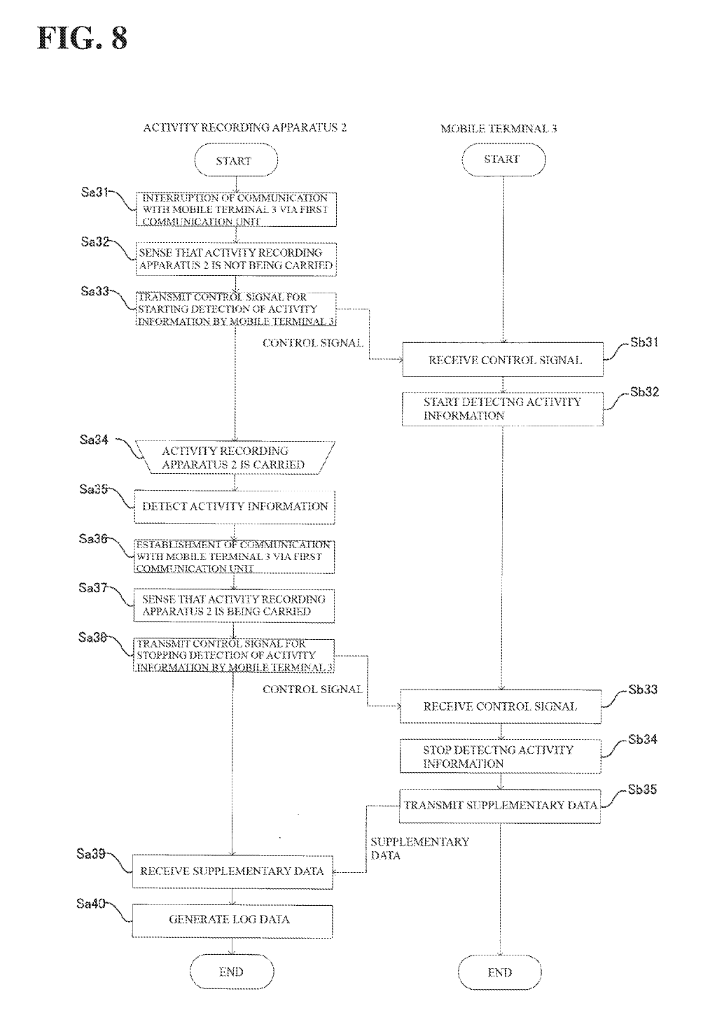

FIG. 8 shows an example of operations of the activity recording system 301.

The example shown in FIG. 8 is also an example in which activity information has not been detected by the activity recording apparatus 2 at first due to the user forgetting to carry the activity recording apparatus 2, but then the activity recording apparatus 2 is carried by the user, and activity information starts to be detected by the activity recording apparatus 2.

First, the controller 10 of the activity recording apparatus 2 senses whether or not the activity recording apparatus 2 is being carried by the user. Here, the activity recording apparatus 2 is not being carried by the user, the activity recording apparatus 2 and the mobile terminal 3 have become separated due to movement of the user, and communication between the activity recording apparatus 2 and the mobile terminal 3 via the first communicators 12a and 22a has been interrupted (step Sa31), and therefore at that time it is sensed that the activity recording apparatus 2 is not being carried (step Sa32).

Upon sensing that the activity recording apparatus 2 is not being carried, the controller 10 causes a control signal that starts the detection of activity information by the mobile terminal 3 to be transmitted from the activity recording apparatus 2 to the mobile terminal 3 using communication between the activity recording apparatus 2 and the mobile terminal 3 via the second communicators 12b and 22b (step Sa33).

The control signal transmitted by the activity recording apparatus 2 is received by the mobile terminal 3 (step Sb31), and in the mobile terminal 3 that received the control signal, the detection of activity information by the detector 21 is started under control of the controller 20 (step Sb32).

Subsequently, when the activity recording apparatus 2 is carried by the user (step Sa34), activity information is detected by the detector 11 of the activity recording apparatus 2 (step Sa35).

Due to the activity recording apparatus 2 being carried, communication between the activity recording apparatus 2 and the mobile terminal 3 via the first communicator 12a and 22a is established (step Sa36), and the controller 10 of the activity recording apparatus 2 senses that the activity recording apparatus 2 is being carried (step Sa37).

Upon sensing that the activity recording apparatus 2 is being carried, the controller 10 causes a control signal that stops the detection of activity information by the mobile terminal 3 to be transmitted from the activity recording apparatus 2 to the mobile terminal 3 (step Sa38).

The control signal transmitted by the activity recording apparatus 2 is received by the mobile terminal 3 (step Sb33), and in the mobile terminal 3 that received the control signal, the detection of activity information by the detector 21 is stopped under control of the controller 20 (step Sb34).

The supplementary data stored in the storage 24 of the mobile terminal 3 is transmitted to the activity recording apparatus 2 at an appropriate timing (step Sb35).

The supplementary data transmitted by the mobile terminal 3 is then received by the activity recording apparatus 2 (step Sa39), and the controller 10 of the activity recording apparatus 2 that received the supplementary data generates log data using the main data stored in the storage 14 and the received supplementary data (step Sa40).

According to the present preferred embodiment as well, similarly to the activity recording systems 101 and 201 described above, it is possible to further maintain the continuity of the main data and also suppress the power consumption of the mobile terminal 3.

Note that although the controller 10 of the activity recording apparatus 2 preferably defines and functions as the data processor that generates log data in the above description, similarly to the activity recording system 1 described above, the controller 20 of the mobile terminal 3 is also able to define and function as the data processor, or the data processor can be a computer device that is provided separate from the activity recording apparatus 2 and the mobile terminal 3.

Descriptions have been given above separately for an example where whether or not the activity recording apparatus 2 is being carried by the user is sensed by the activity recording apparatus 2, an example where it is sensed by the controller 10 of the activity recording apparatus 2 based on the pattern of detection of activity information by the activity recording apparatus 2, and an example where it is sensed by the controller 10 of the activity recording apparatus 2 or the controller 20 of the mobile terminal 3 based on the status of communication between the first communicators 12a and 22a of the activity recording apparatus 2 and the mobile terminal 3. However, these examples may be combined as appropriate.

Also, the processing corresponding to the data processor that is performed by the controller 10 of the activity recording apparatus 2, the controller 20 of the mobile terminal 3, or a computer device provided separate from the activity recording apparatus 2 and the mobile terminal 3 can be provided as a program causing a computer to execute the steps of that processing. Such a program can be provided by being recorded on a non-transitory computer-readable recording medium. Examples of such a computer-readable recording medium include an optical medium such as a CD-ROM (Compact Disc-ROM) and a magnetic recording medium such as a memory card. Such a program can also be provided by being downloaded via a network.

The preferred embodiments described above are to be understood as being in all ways exemplary and in no way limiting. The scope of the present invention is defined by the scope of the appended claims, and all changes which come within the meaning and range of equivalency of the scope of the claims are intended to be included therein as well.

As described above, the present specification discloses the following matter.

The disclosed activity recording system includes: an activity recording apparatus that is carried by a user, detects information corresponding to motion of the user, and records the detected information as main data; a mobile terminal that is used while being carried by the user, detects information that corresponds to motion of the user and is at least a portion of the information that is detected by the activity recording apparatus, and records the detected information as supplementary data; and a data processor that collects the main data and the supplementary data and generates log data, wherein in a case where the main data has a missing period, if the supplementary data has partial data for a period included in the missing period, the data processor compensates for data in the missing period in the main data with use of the partial data.

Also, in the disclosed activity recording system, the activity recording apparatus and the mobile terminal may communicate with each other, at least one of the activity recording apparatus and the mobile terminal may be provided with a sensor that senses whether or not the activity recording apparatus is being carried by the user, and the sensor may control operation of the mobile terminal such that detection of information by the mobile terminal is started if it is sensed that the activity recording apparatus is not being carried by the user, and detection of information by the mobile terminal is stopped if it is sensed that the activity recording apparatus is being carried by the user.

Also, in the disclosed activity recording system, the sensor may be provided in the activity recording apparatus, the sensor may sense whether or not the activity recording apparatus is being carried by the user based on a pattern of detection of information by the activity recording apparatus, and the sensor may cause a control signal corresponding to a result of the sensing to be transmitted from the activity recording apparatus to the mobile terminal.

Also, in the disclosed activity recording system, the activity recording apparatus and the mobile terminal may each include a first communicator that is capable of direct communication, and the sensor may be provided in the mobile terminal, and the sensor may sense whether or not the activity recording apparatus is being carried by the user based on a status of communication between the activity recording apparatus and the mobile terminal via the first communicators.

Also, in the disclosed activity recording system, the activity recording apparatus and the mobile terminal may each include a first communicator that is capable of direct communication and a second communicator that has a longer communication range than the first communicator, and the sensor may be provided in the activity recording apparatus, the sensor may sense whether or not the activity recording apparatus is being carried by the user based on a status of communication between the activity recording apparatus and the mobile terminal via the first communicators, and the sensor may cause a control signal corresponding to a result of the sensing to be transmitted from the activity recording apparatus to the mobile terminal via the second communicators.

Also, the disclosed activity recording apparatus is an activity recording apparatus that is carried by a user, detects information corresponding to motion of the user, and records the detected information as main data, the activity recording apparatus including: a communicator that communicates with a mobile terminal that is used while being carried by the user, detects information that corresponds to motion of the user and is at least a portion of the information that is detected by the activity recording apparatus, and records the detected information as supplementary data; and a data processor that generates log data with use of the main data and the supplementary data that was received from the mobile terminal via the communicator, wherein in a case where the main data has a missing period, if the supplementary data has partial data for a period included in the missing period, the data processor compensates for data in the missing period in the main data with use of the partial data.

Also, another disclosed activity recording apparatus is an activity recording apparatus that is carried by a user, detects information corresponding to motion of the user, and records the detected information, the activity recording apparatus including: a communicator that communicates with a mobile terminal that is carried by the user, detects information that corresponds to motion of the user and is at least a portion of the information that is detected by the activity recording apparatus, and records the detected information; and a sensor that senses whether or not the activity recording apparatus is being carried by the user, wherein the sensor transmits to the mobile terminal, via the communicator, a control signal that controls operation of the mobile terminal such that detection of information by the mobile terminal is started if it is sensed that the activity recording apparatus is not being carried by the user, and detection of information by the mobile terminal is stopped if it is sensed that the activity recording apparatus is being carried by the user.

Also, in the disclosed activity recording apparatus, the sensor may sense whether or not the activity recording apparatus is being carried by the user based on a pattern of detection of information by the activity recording apparatus.

Also, in the disclosed activity recording apparatus, the communicator may have a first communicator capable of direct communication with the mobile terminal and a second communicator having a longer communication range than the first communicator, and the sensor may sense whether or not the activity recording apparatus is being carried by the user based on a status of communication between the mobile terminal via the first communicator, and transmit a control signal corresponding to a result of the sensing to the mobile terminal via the second communicator.

Also, the disclosed activity recording method is an activity recording method for causing a computer to perform: a step of collecting main data acquired by an activity recording apparatus that is carried by a user and detects information corresponding to motion of the user, and supplementary data acquired by a mobile terminal that is carried by the user and detects information that corresponds to motion of the user and is at least a portion of the information that is detected by the activity recording apparatus; and a step of, in a case where the main data has a missing period, if the supplementary data has partial data for a period included in the missing period, compensating for data in the missing period in the main data with use of the partial data.

Also, the disclosed non-transitory computer readable medium contains a program that causes a computer to execute the steps of the activity recording method described above.

An activity recording system, an activity recording apparatus, an activity recording method, and a non-transitory computer readable medium containing a program according to various preferred embodiments of the present invention are applicable to an activity recording system, an activity recording apparatus, an activity recording method, and a non-transitory computer readable medium containing a program that maintain the continuity and the reliability of data even if the user forgets to carry the activity recording apparatus.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An activity recording system comprising:
an activity recording apparatus that is carried by a user, detects information corresponding to motion of the user, and records the detected information as main data;
a mobile terminal that is used while being carried by the user, detects information that corresponds to motion of the user and is at least a portion of the information that is detected by the activity recording apparatus, and records the detected information as supplementary data; and
a data processor that collects the main data and the supplementary data and generates log data; wherein
in a case where the main data has a missing period, if the supplementary data has partial data for a period included in the missing period, the data processor compensates for data in the missing period in the main data with use of the partial data.

2. The activity recording system according to claim 1, wherein
the activity recording apparatus and the mobile terminal communicate with each other;
at least one of the activity recording apparatus and the mobile terminal is provided with a sensor that senses whether or not the activity recording apparatus is being carried by the user; and
the sensor controls operation of the mobile terminal such that detection of information by the mobile terminal is started if it is sensed that the activity recording apparatus is not being carried by the user, and detection of information by the mobile terminal is stopped if it is sensed that the activity recording apparatus is being carried by the user.

3. The activity recording system according to claim 2, wherein the sensor is provided in the activity recording apparatus, the sensor senses whether or not the activity recording apparatus is being carried by the user based on a pattern of detection of information by the activity recording apparatus, and the sensor causes a control signal corresponding to a result of the sensing to be transmitted from the activity recording apparatus to the mobile terminal.

4. The activity recording system according to claim 2, wherein
the activity recording apparatus and the mobile terminal each include a first communicator that is capable of direct communication; and
the sensor is provided in the mobile terminal, and the sensor senses whether or not the activity recording apparatus is being carried by the user based on a status of communication between the activity recording apparatus and the mobile terminal via the first communicators.

5. The activity recording system according to claim 2, wherein
the activity recording apparatus and the mobile terminal each include a first communicator that is capable of direct communication and a second communicator that has a longer communication range than the first communicator; and
the sensor is provided in the activity recording apparatus, the sensor senses whether or not the activity recording apparatus is being carried by the user based on a status of communication between the activity recording apparatus and the mobile terminal via the first communicators, and the sensor causes a control signal corresponding to a result of the sensing to be transmitted from the activity recording apparatus to the mobile terminal via the second communicators.

6. An activity recording apparatus that is carried by a user, detects information corresponding to motion of the user, and records the detected information as main data, the activity recording apparatus comprising:
a communicator that communicates with a mobile terminal that is used while being carried by the user, detects information that corresponds to motion of the user and is at least a portion of the information that is detected by the activity recording apparatus, and records the detected information as supplementary data; and
a data processor that generates log data with use of the main data and the supplementary data that was received from the mobile terminal via the communicator; wherein
in a case where the main data has a missing period, if the supplementary data has partial data for a period included in the missing period, the data processor compensates for data in the missing period in the main data with use of the partial data.

7. An activity recording apparatus that is carried by a user, detects information corresponding to motion of the user, and records the detected information, the activity recording apparatus comprising:
a communicator that communicates with a mobile terminal that is carried by the user, detects information that corresponds to motion of the user and is at least a portion of the information that is detected by the activity recording apparatus, and records the detected information; and
a sensor that senses whether or not the activity recording apparatus is being carried by the user; wherein
the sensor transmits to the mobile terminal, via the communicator, a control signal that controls operation of the mobile terminal such that detection of information by the mobile terminal is started if it is sensed that the activity recording apparatus is not being carried by the user, and detection of information by the mobile terminal is stopped if it is sensed that the activity recording apparatus is being carried by the user.

8. The activity recording apparatus according to claim 7, wherein the sensor senses whether or not the activity recording apparatus is being carried by the user based on a pattern of detection of information by the activity recording apparatus.

9. The activity recording apparatus according to claim 7, wherein
the communicator includes a first communicator capable of direct communication with the mobile terminal and a second communicator having a longer communication range than the first communicator; and
the sensor senses whether or not the activity recording apparatus is being carried by the user based on a status of communication between the mobile terminal via the first communicator, and transmits a control signal corresponding to a result of the sensing to the mobile terminal via the second communicator.

10. A method performed by a computer, the method comprising:
collecting main data acquired by an activity recording apparatus that is carried by a user and detects information corresponding to motion of the user, and supplementary data acquired by a mobile terminal that is carried by the user and detects information that corresponds to motion of the user and is at least a portion of the information that is detected by the activity recording apparatus; and
in a case where the main data has a missing period, if the supplementary data has partial data for a period included in the missing period, compensating for data in the missing period in the main data with use of the partial data.

11. A non-transitory computer readable medium containing a program that causes a computer to execute the activity recording method according to claim 10.
